(19) United States
(12) Patent Application Publication
(10) Pub. No.: US 2007/0096516 A1
(43) Pub. Date: May 3, 2007

(54) Crash-active headrest

(75) Inventors: Norbert Heeg, Dahn (DE); Andreas Diehl, Otterbach (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: KEIPER GmbH & Co. KG

(21) Appl. No.: 11/588,162

(22) Filed: Oct. 26, 2006

(30) Foreign Application Priority Data
Oct. 27, 2005 (DE) 10 2005 051 423.5

(51) Int. Cl. B60N 2/42

(52) U.S. Cl. 297/216.12

(57) ABSTRACT

A headrest for a vehicle seat, in particular a motor vehicle seat, has a carrier, an impact element that can be extended relative to the carrier in the event of a crash, a drive means for extending the impact element, and components for holding and releasing the drive means. The components comprise an electromagnet (17) that is controlled and energized by a control unit, and an actuator box (41). The actuator box (41) is arranged inside the headrest as an internal control unit containing the components needed for energizing the electromagnet (17), and for control purposes it is connected to a control unit (C) arranged outside the headrest.

### CROSS-REFERENCE TO RELATED APPLICATION

The present application claims priority to DE 10 2005 051 423.5, which was filed Oct. 27, 2005. The entire disclosure of DE 10 2005 051 423.5, which was filed Oct. 27, 2005, is incorporated herein by reference.

### BACKGROUND OF THE INVENTION

The present invention relates to a headrest for a vehicle seat, in particular for a motor vehicle seat, having a carrier, an impact element that can be extended relative to the carrier in the event of a crash, a drive means for extending the impact element, and components for holding and releasing the drive means, with the components for holding and releasing including an electrical device that can be controlled and energized by a control unit.

US 2005/0127726 A1 describes a headrest of the type described above, in which an electromagnet is controlled and energized by a control unit located outside the headrest, in particular alongside the vehicle seat. The power stage contained in the control unit is matched to the energy requirement of the electromagnet.

### BRIEF SUMMARY OF SOME ASPECTS OF EXEMPLARY EMBODIMENT

One aspect of the present invention is the provision of improvements to a headrest of the type described above.

In accordance with an aspect of the present invention, a headrest for a vehicle seat, in particular for a motor vehicle seat, is for being connected for controlling purposes to a control unit that is arranged outside the headrest, and the headrest is for operating advantageously when there is a crash. In accordance with an exemplary embodiment of the present invention, the headrest includes a carrier, an impact element that can be extended relative to the carrier when there is a crash, drive means for extending the impact element in response to the drive means being released, and components for holding and releasing the drive means. In accordance with the exemplary embodiment, the components for holding and releasing include at least one electrical device, which is for being energized, and an actuator box. For example, the electrical device can be an electromagnet or an electric motor. As an additional example, the actuator box can be an internal control unit that is positioned inside the headrest, comprises at least one component for at least partially controlling energizing of the electrical device, and is for being operatively connected for controlling purposes to the control unit that is arranged outside the headrest.

As a more specific example, the actuator box can contain the component(s) for at least partially controlling energizing of the electromagnet or the electric motor. The component(s), which can be contained by the actuator box and are for at least partially controlling energizing of the electromagnet or the electric motor, can be generally referred to as the components needed to energize the electromagnet or the electric motor.

Because the actuator box containing the components needed to energize the electromagnet or the electric motor is arranged inside the headrest as an internal control unit, and is connected for control purposes with a control unit (e.g., an external control unit) arranged outside the headrest, the external control unit may be of a conventional type such as is also used to trigger an airbag, while all the special components and circuits needed for the headrest, in particular for acquiring and controlling power for the electromagnet or the electric motor, are arranged inside the headrest. This not only saves on installation space, but because the headrest has a more universal interface it has a wider range of possible uses, i.e. less adjustment is needed to fit special vehicles and vehicle seats.

An improved modular structure of the headrest is achieved if the actuator box is provided in the form of a mechanical and electrical control unit that also contains the electromagnet or the electric motor and the other components for supporting the drive, i.e. all the necessary support and control components. Preferably, the actuator box is correspondingly provided with an almost closed housing within which the components are arranged and with which they can be mounted on the carrier. The actuator box thus preferably forms a (mechanically and electrically) testable unit.

In electrical terms, these components contained in the actuator box include preferably a power stage, i.e. for example a power transistor series-connected to the electromagnet to energize the electromagnet or the electric motor, with the transistor serving as a controllable switch for switching on and off the power to the electromagnet or the electric motor. Instead of the power transistor, another power circuit or a relay can be provided so that, in the following specification, any mention that is made of the power transistor should also be taken to include these other variants.

For safety and control purposes a protective circuit and/or at least one diagnostic module may be provided for the power transistor, also a free-wheeling diode may be provided in parallel to the electromagnet or electric motor. The components, in particular the power transistor and the electromagnet, may be combined together, for example they may be jointly encapsulated or potted, to form a one-piece component.

For the electrical connection of the headrest preferably at least one control wire, which is preferably used to control the power transistor, and two power supply wires that supply the power required to energize the electromagnet or the electric motor, are led into the headrest where they are connected in particular to the actuator box. The control wire carries—at usually the same voltage—less power compared with that carried by the supply wires, with the control wire preferably being connected to the control unit that is arranged outside the headrest, the lower power being supplied by an output from the control unit that is arranged outside the headrest, and the output supplied by the control unit that is arranged outside the headrest also being usable to control an airbag. It is theoretically conceivable not to control the actuator box via the control wire but instead to modulate the supply voltage with a control signal in order to eliminate a wire. However, the greater electronic complexity involved is an obstacle.

In mechanical terms, the components contained in the actuator box preferably include a movable pawl for securing the drive means, with the pawl being held in a specific position by means of a permanent magnet whose magnetic field is opposed to that of the energized electromagnet. Such a pawl preferably secures a spring as the drive means when the electromagnet is de-energized and releases the spring when the electromagnet is energized.

Other aspects and advantages of the present invention will become apparent from the following.

### BRIEF DESCRIPTION OF THE DRAWINGS

The invention is described in detail below with reference to an exemplary embodiment depicted in the drawings, in which:

FIG. 1 a block circuit diagram of the electronic components of the exemplary embodiment,

FIG. 2 a perspective view of the exemplary embodiment together with the vehicle seat prior to a crash, and

FIG. 3 a perspective view of the exemplary embodiment following a crash.

### DETAILED DESCRIPTION OF EXEMPLARY EMBODIMENT

Referring now in greater detail to the drawings, in which like numerals refer to like parts throughout the several views, a headrest 1 for a motor vehicle seat 3 is attached to the backrest 5 of the vehicle seat 3 by means of at least one and preferably two headrest rods 7. The crash-active headrest 1 includes a carrier 9 that is arranged and mounted on the headrest rods 7, and an impact element 11 that is arranged in front of the carrier 9 and is attached to the carrier 9 by a four-bar linkage 13. The kinematics of the headrest 1 are described in detail in US 2005/0127726A, the entire disclosure of which is explicitly incorporated herein by reference. In the normal case, the impact element 11 is arranged on the front side of the carrier 9 and bears against the carrier 9, as a result of the four-bar linkage 13 being folded together (e.g., the four-bar linkage being in its relatively compact configuration). The carrier 9 and the impact element 11 are upholstered and/or covered on their opposite sides, so that when they are combined the headrest 1 forms a substantially integral unit.

At least one crash sensor, designated in short as sensor S, and preferably several such sensors S, are arranged within the motor vehicle. As a rule (e.g., typically), the sensors S are arranged outside the vehicle seat 1. The sensors S are attached to a central control unit C of the motor vehicle, and the control unit C is typically external of the headrest 1. The control unit C can be a conventional device that also controls the airbags of the motor vehicle. The control unit C has, for example, an output voltage of 12 V and a maximum current strength of 1.2 A. Inside the headrest 1 a drive means 15, which for the exemplary embodiment is preferably (e.g., optionally) a spring, more specifically a double-leg spring, is provided for the four-bar linkage 13, and in the normal case this spring is held by means of a magnet and a pawl, as is described in DE 102 15 054 A1, US 2006/012226 A1 and U.S. Pat. No. 7,108,320 B2. The entire disclosure content of each of DE 102 15 054 A1, US 2006/012226 A1 and U.S. Pat. No. 7,108,320 B2 is explicitly incorporated herein by reference. The holding magnet includes of a permanent magnet, which in the normal case indirectly secures the drive means 15 (e.g., the spring) for the four-bar linkage 13, and also of an electromagnet 17, which in the normal case remains de-energized but which in the event of a crash is intended to build up an opposing field to the magnetic field of the permanent magnet, thereby reducing the overall holding force to such an extent that the drive means 15 is released. Instead of the holding magnet it is also possible to provide an electric motor to release the drive means 15.

The electromagnet 17, i.e. the coil thereof, is connected in series with a power transistor 21, for example an npn transistor, by connecting the electromagnet 17 on the one hand to the positive pole+of the vehicle's electrical system (usually 12 V or 24 V), and on the other hand to the collector of the power transistor 21, while the emitter of the power transistor 21 is connected to the negative pole—of the vehicle's electrical system. The two power supply wires 23 required between the electromagnet 17 and the power transistor 21 in the headrest 1, on the one hand, and the rest of the vehicle's electrical system accessible via the vehicle seat 3, on the other hand, are passed through the, for example, hollow headrest rods 7. The base of the power transistor 21 is connected to the control unit C of the motor vehicle, namely to an output of the control unit C that can be used for controlling an airbag. For this purpose, a third wire, i.e. a control wire 25, is led from the headrest 1 to the vehicle seat 3, preferably also through the headrest rod. The maximum power transmitted by the control wire 25 is the output power of the control unit C, i.e. a much lower power than that transmitted via the power supply wires 23.

Further electronic components are connected in a known manner to the electromagnet 17 and the power transistor 21. A free-wheeling diode 31 is preferably connected in parallel with the electromagnet 17 and short circuits the current from the collapsing magnetic field when the electromagnet 17 is switched off. A protective circuit 33, for example a reverse polarity protection diode, is connected in parallel with the power transistor 21, i.e. between the emitter and collector. Diagnostic modules 35, which for example monitor the functionality of the electromagnet 17 and of the contacts, are preferably connected between the collector and the base and the emitter and the base.

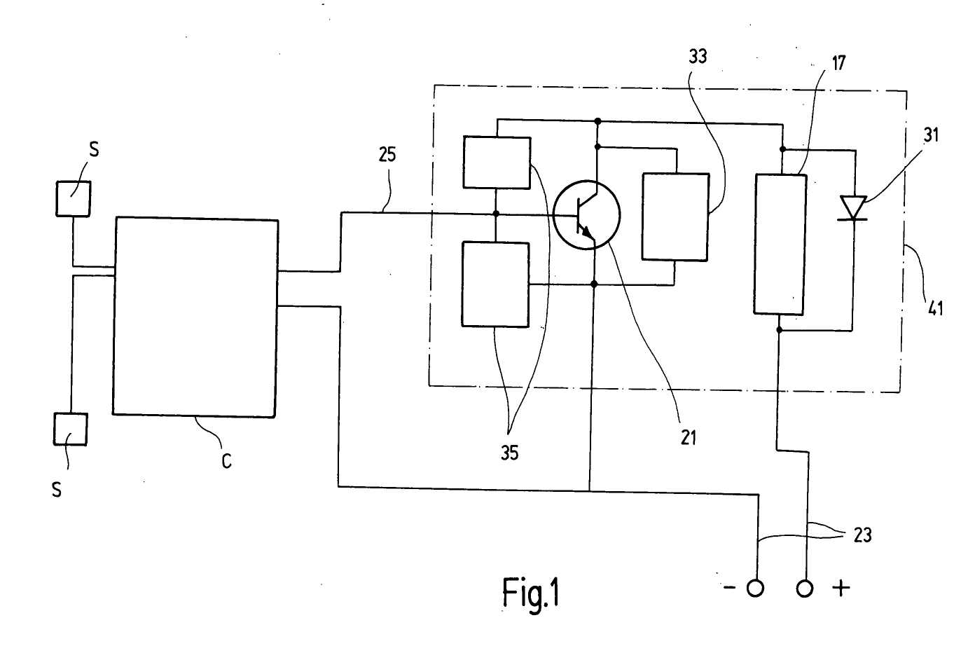

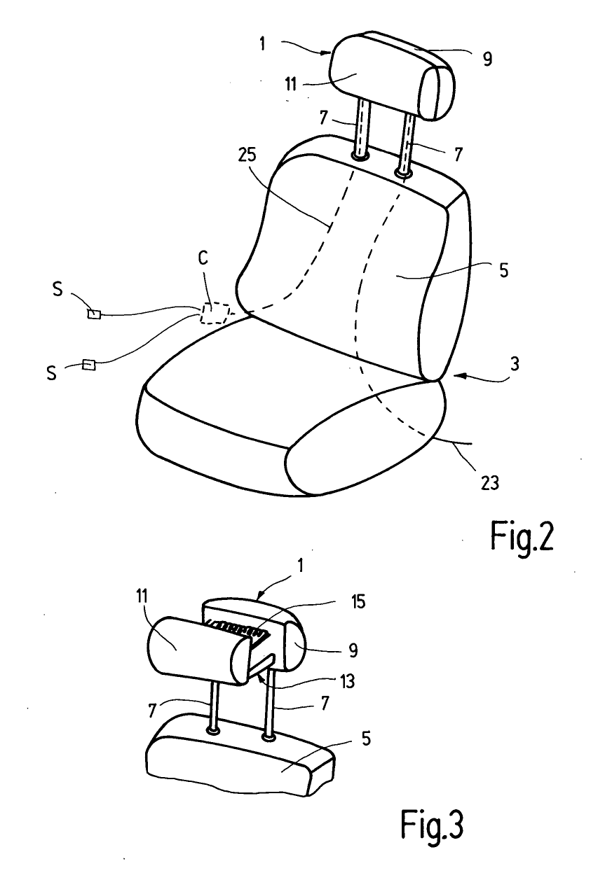

The holding magnet together with the electromagnet 17, the pawl for securing the spring, the power transistor 21 and the electronic components described above, i.e. the mechanical and electrical components used to hold and release the drive means 15, are structurally grouped in an actuator box 41 which is preferably provided with an almost closed housing and is mounted on the carrier 9. The actuator box 41 is thus both the mechanical and the electrical control unit used for controlling the drive means 15 and thus for triggering the crash-active headrest 1. The actuator box 41 is completely arranged within the headrest 1 as an internal control unit, and the two power supply wires 23 and the control wire 25 are connected to the actuator box 41. Therefore, the actuator box 41 is a testable unit during the manufacturing stage. The actuator box 41 is schematically illustrated by the alternating dash/dot line in FIG. 1, and the two power supply wires 23 and the control wire 25 crossing the alternating dash/dot line are schematically illustrative of the two power supply wires 23 and the control wire 25 being connected to the actuator box 41.

If a crash occurs and the sensors S report this to the control unit C, the control unit C transmits a signal via control wire 25 to the actuator box 41, in response to which the power transistor 21 becomes conductive. The electromagnet 17 is now energized via the power supply wires 23 and, in the manner already described, triggers the drive means of the four-bar linkage 13 which extends the impact element 11 from its original position forward into a crash position. The head of the occupant of the seat comes into early contact with the impact element 11. Once the signal is terminated, the power transistor 21 becomes non-conductive once more and the current in the electromagnet 17 dissipates via the freewheeling diode 31.

It will be understood by those skilled in the art that while the present invention has been discussed above with reference to an exemplary embodiment, various additions, modifications and changes can be made thereto without departing from the spirit and scope of the invention as set forth in the following claims.

What is claimed is:

1. A headrest that is for a vehicle seat, is for operating advantageously when there is a crash, and is for being connected for controlling purposes to a control unit that is arranged outside the headrest, the headrest comprising:
a carrier,
an impact element that can be extended relative to the carrier when there is a crash;
drive means for extending the impact element in response to the drive means being released;
components for holding and releasing the drive means, wherein the components comprise
(a) at least one electrical device selected from the group consisting of an electromagnet and an electric motor, wherein the electrical device is for being energized, and
(b) an actuator box that is positioned inside the headrest, wherein the actuator box comprises at least one component for at least partially controlling energizing of the electrical device, and the actuator box is for being operatively connected for controlling purposes to the control unit that is arranged outside the headrest, whereby the actuator box is an internal control unit.

2. The headrest according to claim 1, wherein the actuator box is a mechanical and electrical control unit that comprises the electrical device.

3. The headrest according to claim 1, wherein the at least one component for at least partially controlling energizing of the electrical device comprises a component that is:
connected in electrical series with the electrical device, and
selected from the group consisting of a power transistor, a power circuit and a relay.

4. The headrest according to claim 3, including at least one component selected from the group consisting of:
a protective circuit for the power transistor, and
at least one diagnostic module for the power transistor, the electrical device or any combination thereof.

5. The headrest according to claim 1, wherein:
the electrical device is the electromagnet; and
the at least one component for at least partially controlling energizing of the electromagnet comprises a power transistor that is connected in electrical series with the electromagnet.

6. The headrest according to claim 1, wherein at least one control wire and the two power supply wires are located in the headrest.

7. The headrest according to claim 6, wherein the control wire carries less power than the power supply wires.

8. The headrest according to claim 6 in combination with at least the control unit that is arranged outside the headrest, wherein the control wire is connected to an output of the control unit that is arranged outside the headrest, and the output of the control unit that is arranged outside the headrest can also be used to control an airbag.

9. The headrest according to claim 1, wherein:
the drive means comprises a spring; and
the holding and releasing components comprise a moveable pawl for at least indirectly holding the spring.

10. The headrest according to claim 9, wherein:
the electrical device is the electromagnet;
the electromagnet is operative for providing a magnetic field when the electromagnet is energized; and
the holding and releasing components comprise a permanent magnet that has a magnetic field that is for holding the pawl and is opposed to the magnetic field provided by the electromagnet.

11. The headrest according to claim 9, wherein the pawl is contained in the actuator box.

12. The headrest according to claim 1, wherein the actuator box is a testable unit.

13. The headrest according to claim 1, wherein the actuator box comprises a housing that is almost closed.

14. The headrest according to claim 1, wherein the actuator box is mounted on the carrier.

15. The headrest according to claim 1 in combination with at least a motor vehicle, the vehicle seat, and the control unit that is arranged outside the headrest, wherein:
the vehicle includes both the vehicle seat and the control unit that is arranged outside the headrest,
the vehicle seat includes a backrest to which the headrest is mounted, and
the actuator box is connected for controlling purposes to the control unit that is arranged outside the headrest.

16. The headrest according to claim 2, wherein the at least one component for at least partially controlling energizing of the electrical device comprises a component that is:
connected in electrical series with the electrical device, and
selected from the group consisting of a power transistor, a power circuit and a relay.

17. The headrest according to claim 5, wherein the power transistor and the electromagnet are connected with each other to form a one-piece component.

18. The headrest according to claims 6, wherein the control wire and the power supply wires are connected to the actuator box.

19. The headrest according to claim 6, wherein:
the headrest is in combination with at least
the control unit that is arranged outside the headrest, and
an electrical system that is arranged outside the headrest;
the power supply wires are respectively connected to positive and negative poles of the electrical system; and
the control wire
is connected to the control unit that is arranged outside the headrest, and
carries less power than the power supply wires.

20. The headrest according to claim 3, wherein:
the drive means comprises a spring;
the holding and releasing components comprise a moveable pawl for at least indirectly holding the spring;
the electrical device is the electromagnet;
the electromagnet is operative or providing a magnetic field when the electromagnet is energized; and
the holding and releasing components comprise a permanent magnet that has a magnetic field that is for holding the pawl and is opposed to the magnetic field provided by the electromagnet.

21. The headrest according to claim 1, wherein both the electrical device and the at least one component for at least partially controlling energizing of the electrical device are positioned in the actuator box.

22. A headrest that is for a vehicle seat, is for operating advantageously when there is a crash, and is for being connected for controlling purposes to a control unit that is arranged outside the headrest, the headrest comprising:
a carrier,
an impact element mounted so that the impact element can be moved away from the carrier when there is a crash;
at least one spring for moving the impact element away from the carrier in response to the at least one spring being released;
components for holding and releasing the at least one spring, wherein the components comprise
(a) at least one electrical device selected from the group consisting of an electromagnet and an electric motor, wherein the electrical device is for being energized, and
(b) an actuator box that is positioned inside the headrest, wherein the actuator box comprises at least one component for at least partially controlling energizing of the electrical device, and the actuator box is for being operatively connected for controlling purposes to the control unit that is arranged outside the headrest, whereby the actuator box is an internal control unit.
